(19) United States
(12) Patent Application Publication
(10) Pub. No.: US 2026/0245447 A1
(43) Pub. Date: Aug. 20, 2026

(54) METHOD, SYSTEM AND APPARATUS FOR LOCAL AND REMOTE MONITORING AND REMOTE CONTROL IN BUILDINGS AND THE LIKE

(71) Applicant: CAPPSULE HOLDINGS PTY LTD, New South Wales (AU)

(72) Inventors: Adalbert Hutter, New South Wales (AU); Maksim Tesanovic, New South Wales (AU)

(73) Assignee: CAPPSULE HOLDINGS PTY LTD, New South Wales (AU)

(21) Appl. No.: 19/159,304

(22) PCT Filed: Feb. 26, 2024
(86) PCT No.: PCT/AU2024/050154

§ 371 Date: Aug. 23, 2025

(30) Foreign Application Priority Data
Feb. 24, 2023 (AU) 2023900489

(51) Int. Cl. G08B 21/18; H04W 4/33; H04W 4/80

(52) U.S. Cl. CPC G08B 21/182; H04W 4/33; H04W 4/80

(57) ABSTRACT

A system for monitoring activities within an enclosed environment includes a back-end server, a base station, a mobile device, and one or more sensors configured to detect an ambient temperature, an ambient pressure, an ambient sound or noise level, ambient carbon dioxide levels, beacon IDs of wireless sources, a vibration, a movement of objects, a movement of the base station, a location of smart tags, a location of animals, a movement of animals, or a physiological state of animals. The system is adapted to perform a processing that includes a preliminary analysis of data or an encryption of data, send one or more measurements or data elsewhere for processing, receive results of the local processing back at the base station, and take action such as issuing an alert, a message, a prompt, a sound, a notification, and a display of measured levels.

### CROSS REFERENCE TO RELATED APPLICATIONS

The present application claims the priority benefits of International Patent Application No. PCT/AU2024/050154, filed on Feb. 26, 2024, and claims benefit of AU 2023900489, filed on Feb. 24, 2023, which are hereby incorporated herein by reference in their entireties.

### FIELD OF THE INVENTION

The present invention relates to the field of local and remote monitoring of, and to remote control relating to, inhabited and uninhabited buildings and the like.

### BACKGROUND OF THE INVENTION

In recent years in Australia, there has been major growth in the construction of apartment buildings in the more-densely populated regions of the cities and in areas that are popular with tourists. The purchase or rental of apartments in such areas is attractive to the demographic of younger workers who are seeking an entry to the housing market or who are attracted to accommodation which is close to the employment opportunities close to the inner-city or other workplaces. Such accommodation is also attractive to members of the “empty nester” generations who wish to realize the appreciation in the value of the family home but who also wish to remain in the high-amenity regions that are close to the population centres.

The purchase of apartments is also attractive to overseas investors who wish to “offshore” assets to Australia, and to property investors in general.

It follows that not all apartments are inhabited by owner-occupiers. The owner-occupancy rate varies widely, and a large proportion of apartment buildings are developed to operate as serviced apartments or as “short-stay” or “short-term rental” properties. Short-stay/short-term rental properties in desirable locations are attractive and convenient locations for renters who plan to hold group parties or celebrations such as sporting grand-finals weekends.

In recent years, various Australian States have legislated to restrict the activities which may take place in short-stay rentals, to impose penalties on apartment owners who have repeatedly allowed their rental properties to be used for undesirable activities, and to allow third parties to claim compensation for damage done. For example, the Australian State of Victoria has proscribed the activities of:
unreasonably creating any noise likely to substantially interfere with the peaceful enjoyment of another apartment;
behaving in a manner likely to unreasonably and substantially interfere with the peaceful enjoyment of another apartment;
allowing property to be used to cause a substantial hazard to the health, safety and security of another person;
unreasonably and substantially obstructing the lawful use of other property; and
substantially damaging or altering an apartment or common property.

Breach of the above noted prohibitions can entitle a third party to claim compensation, and repeated breach can result in the imposition of penalties.

The evidence is that the legislation has encouraged some potential short-stay apartment renters to move their activities to larger houses in less densely populated suburbs where there is less likelihood of neighbours taking action.

Rental organizations such as Airbnb have addressed the issues in part in their terms of usage. For example, Airbnb has introduced a “zero tolerance” policy regarding the hosting of parties in a short-stay rental property.

Prohibiting undesirable activity by legislation or by contractual terms does not solve the problem. There is a need to be able to detect that undesirable activity while it is underway, or preferably as it starts, and to provide information to rectify the problem before damage is done. At the same time, landlords need to comply with legislative requirements such as privacy laws, anti-surveillance laws, and anti-stalking laws. It is also desirable that landlords adhere to generally-accepted privacy expectations of potential customers, whether or not those expectations are enforceable under the law.

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realization of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Previous attempts at determining undesirable or prohibited activities have been provided by proprietary systems of Minut™, Noise Aware™, Samsung™, Nest™ and Party Squasher™. In one form or another one or more of these previous attempts have provided abilities and functionalities for detection of parties, loud noises, air quality detection, breaking glass, large crowds, motion, mould, and smart alerts for existing smoke and carbon monoxide alarms. The operation of these previous solutions has provided wizard set up, Google™ and Alexa™ home compatibility, integration with booking platforms, smart locks and PMS. They have all provided over the air updates and some have obviated need for video cameras. None, however, have integrated all the above parameters to aggregate a detection or provided the following parameters for their operation:
a tenant/occupier interface for messaging, house rules and guide information;
monitoring individual assets, including GPS tracking;
detecting if an item has been moved or modified, e.g., door/cupboard has been opened.

The preceding discussion of background art is intended to facilitate an understanding of the present invention only. The discussion is not an acknowledgement or admission that any of the material referred to is or was part of the common general knowledge as at the priority date of the application.

### SUMMARY OF THE INVENTION

In one particular aspect, embodiments of the present invention are suitable for use in monitoring activities and conditions in buildings, such as in short term (residential) rentals, hotels, motels, bed-and-breakfast establishments, child care facilities, aged care facilities, in-home care of the aged, infirm or ill, educational institutes, military establishments, property management, strata developments (including common property), asset management facilities, and warehouses or other logistic facilities. In another aspect, embodiments of the present invention are suitable for use in monitoring activities and conditions in mobile environments, such as motor homes, caravans, and houseboats.

In yet another aspect, embodiments of the present invention are suitable for use in monitoring the use, condition, or position of articles, such the location or movement of valuables such as art works or electronic appliances and/or devices, the degree of usage of a commodity such as oil or liquified petroleum gas (LPG) to be used for heating or cooking, or the physical state of an item or object such as whether a door or window is open or closed.

In yet another aspect, embodiments of the present invention are suitable for monitoring the use, condition, position or state of such appliances, devices or commodities, whether or not those appliances, devices or commodities are associated with a stationary or movable inhabitable environment (such as a building or vehicle).

In yet another aspect, embodiments of the present invention are suitable for monitoring human and other mammalian vital signs. Examples of such uses include monitoring for conditions that are conducive to heart attacks (myocardial infarction), stroke, and SIDS (sudden infant death syndrome).

In yet another aspect, embodiments of the present invention are suitable for monitoring the consumption of medications by a patient, and for monitoring the states of a supplies of medications.

In yet another aspect, embodiments of the present invention are suitable for monitoring the presence, condition or activities of animals such as pets, nuisance native animals, feral animals and vermin.

It will be convenient to hereinafter describe the invention in relation to installations in short term rental properties, however it should be appreciated that the present invention is not limited to that use only.

An object of the present invention is to provide apparatus and systems to allow the identification of conditions which could develop into an undesirable outcome in environments such as rental properties, childcare facilities, healthcare facilities, aged-care facilities, educational institutions, in-home care environments, and commercial or business environments.

A further object of the present invention is to allow the communication of such potential conditions to local and/or remotely-located persons to allow the initiation of pre-emptive rectification of the situation.

A further object of the present invention is to provide apparatus and systems to allow for post-incident analysis, reporting and action.

A further object of the present invention is to provide apparatus and systems to allow for the monitoring of the physiological state of a person or other animal.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

Generally, the present invention provides a system for one or a combination of monitoring and managing activities within a stationary or moving environment, including a base station and comprising one or a combination of sensors to sense one or more of:
ambient temperature;
ambient pressure;
ambient sound or noise level;
ambient carbon dioxide levels;
the beacon IDs of wireless sources;
vibration;
movement of objects;
movement of the base station;
the location of smart tags;
the location of animals;
the movement of animals;
the physiological states of animals;
the system being adapted to do one or a combination of:
local processing comprising preliminary analysis of data and/or encryption of data;
send one or more measurements/data elsewhere for processing;
receive the results of processing back at the base station; and
take action comprising one or a combination of: issuing an alert, a message, a prompt, a sound, a notification and; a display of measured levels.

In the system of embodiments disclosed herein one or more of the sensors are in communication and remotely located from the base station. Further, at least one of the sensors may be integral with the base station. Preferably, the sensor to sense the movement of objects comprises at least one pyro-electric infrared (PIR) motion detector.

The smart tags may comprise one or a combination of
at least one RFID tag; and,
at least one BLE tag.

In preferred embodiments, the processing (local, remote, or combined) identifies the spatial location of objects. With preferred embodiments, the spatial location is in 3 dimensions. The objects may comprise objects which have body heat.

Preferably, the processing being one or a combination of local and remote processing, determines at least one of the number of:
persons; and
other animals,
that are within the sensing range of at least one of the sensors.

According to preferred embodiments of the system disclosed, the processing is one or a combination of local and remote processing, detects that a party is underway. Furthermore, in preferred embodiments of the system, the processing takes account of one or a combination of:
the number of wireless devices that are within the range of the relevant sensor(s) compared with the number of wireless devices that are normally/on average/according to past historical data within the range of the relevant sensor(s);
the number of persons that are within the range;
the carbon dioxide level compared with normal, or as usually varies;
the temperature as compared with normal for the season and time of day; and
random, but predictable, events.

A random but predictable event may be one or a combination of:
a bus driving past increasing sound levels; and
the number of wireless devices detected.

According to preferred embodiments of the system disclosed, the processing (local, remote, or combined) identifies the physiological state of a person or some other animal. It is preferred that the physiological state comprises heart rate and/or respiration rate.

Generally, the present invention also provides a method of detecting activity that exceeds a predetermined threshold of activity in a monitored volume of space, the method comprising the steps of:
detecting environmental and/or physical parameters of stationary and moving objects within the monitored volume of space;
communicating the detected environmental and/or physical parameters to a base station for processing to determine which, if any, parameters exceed predefined parameter thresholds set respectively for each parameter;
signal any one or a combination of parameters that have been determined to exceed their predefined thresholds.

In preferred embodiments of the method disclosed, the environmental and/or physical parameters are selected from one or a combination of:
air quality;
temperature,
pressure;
humidity;
noise levels;
carbon dioxide levels;
movement of objects;
breaking of glass;
absence of objects;
locations of smart tags;
the location of animals;
the movement of animals;
the physiological states of animals;
identification signals of wireless sources within communication range of the base station;
location, movement or connection of a component of base station.

Generally, the present invention also provides a computer program product including:
a computer usable medium having computer readable program code and computer readable system code embodied on said medium for detecting activity that exceeds a predetermined threshold of activity in a monitored volume of space within a data processing system, said computer program product including:
computer readable code within said computer usable medium for performing the method steps as disclosed herein.

Generally, the present invention also provides a base station adapted for operative connection with the system as disclosed herein.

Generally, the present invention also provides apparatus for monitoring and managing activities within a stationary or moving environment, the apparatus comprising:
a base station, the base station comprising, or being operably connected to,
   sensors to sense one or more of:
ambient temperature;
ambient pressure;
ambient sound level;
ambient carbon dioxide levels;
the beacon IDs of wireless sources;
vibration;
movement of objects;
movement of the base station;
the location of wireless tags;
the location of animals;
the movement of animals,
   the base station being adapted to:
receive data from the one or more sensors;
perform one or a combination of:
local processing on at least some of that received data;
send:
   at least some of that received data; and/or
   the results of locally processing at least some of the received data which has been locally processed,
to a remote processing facility which is adapted to perform remote processing on the data that it receives;
receive the results of processing back at the base station; and
take action comprising one or a combination of: issuing an alert, a message, a prompt, a sound, a notification and; a display of measured levels.

In certain embodiments, one or more of the sensors are in communication with, and located remotely from, the base station.

In other embodiments, at least one of the sensors is integral with the base station.

Preferably, with embodiments of the base station disclosed herein, the sensor to sense the movement of objects comprises at least one pyro-electric infrared (PIR) motion detector.

Preferably, with embodiments of the base disclosed herein, the processing (local, remote, or combined) identifies the spatial location of objects. The spatial location may be in 3 dimensions. Further, the objects comprise objects which have body heat.

Preferably, with embodiments of the base disclosed herein, the processing (local, remote, or combined) determines at least one of the number of:
persons; and
other animals,
that are within the sensing range of at least one of the sensors.

Preferably, with embodiments of the base disclosed herein, the processing (local, remote, or combined) detects that a party is underway.

Preferably, with embodiments of the base disclosed herein, the processing takes account of one or a combination of:
the number of wireless devices that are within the range of the relevant sensor(s) compared with the number of wireless devices that are normally/on average/according to past historical data within the range of the relevant sensor(s);
the number of persons that are within the range;
the carbon dioxide level compared with normal, or as usually varies;
the temperature as compared with normal for the season and time of day;
and random, but predictable, events.

According to preferred embodiments of the method, system and apparatus disclosed herein, a random but predictable event is one or a combination of:
a bus driving past increasing sound levels; and
the number of wireless devices detected.

According to preferred embodiments of the system disclosed, the processing (local, remote, or combined) identifies the physiological state of a person or some other animal. It is preferred that the physiological state comprises heart rate and/or respiration rate.

Other aspects and preferred forms are disclosed in the specification and/or defined in the appended claims, forming a part of the description of the invention.

In essence, embodiments of the present invention stem from the realization that
there is a need to provide apparatus and systems to allow the identification of conditions which could develop into, or which have developed into, an undesirable outcome in environments such as rental properties, healthcare facilities, aged-care facilities, in-home care environments, and commercial or business environments;
there is a need to communicate the existence of such potential or actual conditions to local and/or remotely-located persons to allow the initiation of pre-emptive or remedial rectification of the situation.

Advantages provided by embodiments of the present invention comprise the following:
the early identification of developing issues;
the provision of data-driven insights into conditions and recommendations on what action to take;
the provision of resources to protect property and assets from damage or damaging behaviour;
the provision of resources to take action to protect individuals who are at risk of harm,
the ability to remotely monitor, and access, real time information;
data driven accountability, which in turn can lead to easing the burden of insurance premiums, insurance claims, and liability in general;
potential for integration with other electronic devices or platforms; and
the ability to maintain the privacy of individuals while, at the same time, providing the above-listed advantages.

In particular it will be seen that, according to the present invention, the combination a base station, smart tags and data sensors form an ecosystem which is capable of performing sophisticated analysis of data to provide accurate inferences about the state of a physical environment and of the people within that environment. For example, according to embodiments of the invention, shape detection may indicate that a person is lying on the ground, while a smart tag may detect that a walking frame has fallen over, and physiological data may indicate that a patient is unconscious. From these separate data points it can be confidently inferred that a patient has fallen and is unconscious.

It will also be seen that such an ecosystem can inter-operate with other devices, or with data from other devices. For example, embodiments of the presently described ecosystem are capable of receiving data from a video doorbell to establish that an event has occurred, or to confirm an event that has also been inferred by the ecosystem, or to provide evidence of an event.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 is a high-level block schematic diagram which illustrates an overview of software architecture according to a first embodiment of the present invention;

FIG. 2 is a high-level network diagram which illustrates a system according to that first embodiment of the present invention;

FIG. 3 is a high-level block diagram which illustrates hardware according to that first embodiment of the present invention;

FIGS. 4 to 6 are plan views which illustrate installations of apparatus according to exemplary embodiments of the present invention;

FIG. 7 is a high-level block diagram which illustrates hardware according to another aspect of first embodiment of the present invention;

FIG. 8 is a set of charts which list the functionality, at a high-level, of resources which are used by embodiments of the present invention;

FIG. 9 is a set of drawings which illustrate the external appearance of a tag according to embodiments of the present invention;

FIG. 10 is a set of drawings which illustrate some of the internal components of the tag according to embodiments of FIG. 9; and

FIG. 10 is a set of drawings which illustrate a circuit board which is one of the internal components of the tag according to embodiments of FIG. 9.

### DESCRIPTION OF THE PREFERRED EMBODIMENTS

### Hardware and Software

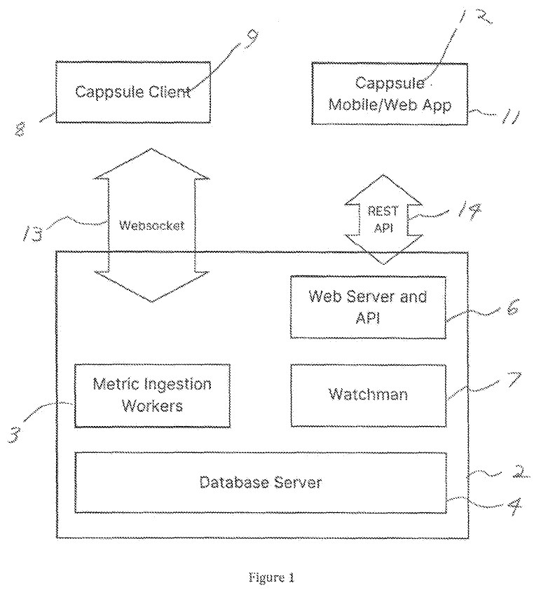

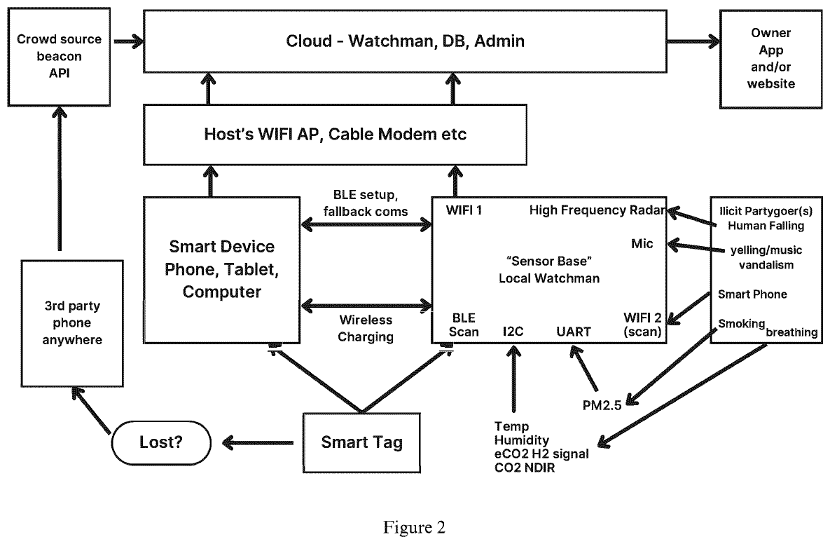

As is illustrated in the block schematic diagram of FIG. 1, the architecture of a system 1 according to a first embodiment of the present invention comprises a back-end server 2, base station 8, and at least one mobile device 11. The base station 8 and the back-end server 2 are able to intercommunicate with each other over a communications channel 13. The communications channel 13 is preferably implemented using TCP/IP protocols. The mobile device 11 and the back-end server are able to intercommunicate with each other using an API (application programming interface) 14. The API 14 is preferably a FastAPI, developed using the Python programming language.

The back-end server 2 includes metric ingestion workers 3, a Web server and API 6, a watchman 7, and a database server 4. The metric ingestion workers 3 take data from the client base station, for example, base station 8 for storage in the database 4.

The base station 8 is provided to run a client application 9 and is preferably written in the Python programming language.

The mobile device 11 can run client software 12. Preferable forms of mobile device include tablets, and mobile telephones running operating systems such as Android or iOS. The client software 9 is preferably a daemon written in Python.

Preferably:
the database 4 is hosted on a cloud platform, such as Google Cloud;
the metric ingestion workers 3 are implemented using Google Cloud Edge;
the web server and API 6 are implemented using Google Containers;
authentication and push notifications are implemented using Firebase; and
Cloudflare is used for domains and DNS, firewall and bot protection.

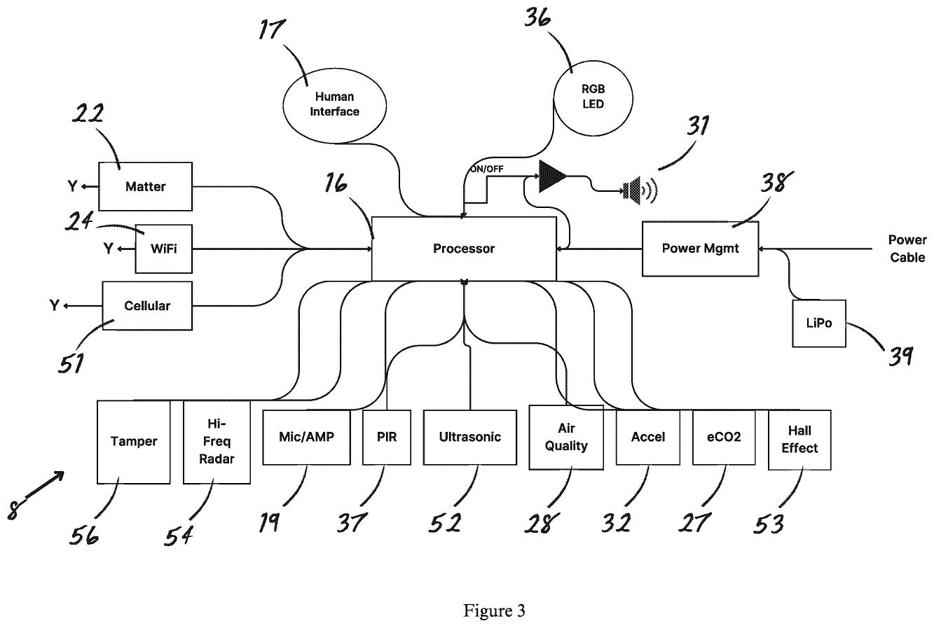

As is illustrated in the high level block diagram of FIG. 3, the base station 8 is preferably implemented using a system-on-chip (SoC) or system-on-module (SOM) 16, a power supply, and peripheral devices including for input/output, environmental sensing (such as a microphone for audio pick-up), and for wireless communication.

Specifically preferred components of the base station 8 include:
a touchscreen interface 17 for the acceptance or silencing of alerts (which is not illustrated in the drawings);
a noise level indicator 18 (which is not illustrated in the drawings);
a microphone 19 for monitoring ambient sound levels, to be used for detecting loud sounds or glass breaking;
a sound pressure detector 21 for identifying the occurrence of, for example, glass breaking (which is not illustrated in the drawings);
a “Matter”, Bluetooth, Zigbee or other low power wireless interface 22 to listen for Bluetooth or the like beacons and for communication with tracking tiles;
a Wifi interfaces 24 for network connection and to listen for Bluetooth service set identifiers (SSID);
a cellular interface 51 for connection to the public telephone network;
an infrared (IR) transmitter 26 (which is not illustrated in the drawings) to provide functionality such as remote control of devices;
carbon dioxide (CO2) sensors 27 and fine particulate matter 28 air quality monitors;
temperature, humidity sensors and pressure sensors 29;
a speaker or other device 31 for generating audible alerts;
one or more accelerometers 32 for detecting movement;
a GPS device 33 for detecting geographic location (which is not illustrated in the drawings);
a Zigbee controller (which is not illustrated in the drawings)
a LED glow light 36 or other light-emitting device for visually signalling warnings;
PIR (passive infra red) motion detector module 37;
a power management module 38;
a lithium-polymer battery 39;
an ultrasonic motion detector 52;
a Hall effect detector 53
a high-frequency radar module 54; and
a tamper switch 56.

The client software 9 in the base station 8 is a daemon written in the Python programming language. It preferably runs under a Linux operating system in a docker container with automatic updates. It functions to manage initial setup of the base station 8 and WiFi connectivity, to register inputs after polling the sensors which are connected to device 8, and to communicate (preferably over the Internet) with the metric ingestion workers 3. It also preferably sends binary packets back to the ingestion workers 3 via the Internet.

The back-end server 2 is able to serve multiple base stations 8, in communication with mobile devices 11.

The metric ingestion workers 3 receive signals from the base stations 8. These metric ingestion workers are distributed functions that are preferably implemented using the Typescript open source programming language and preferably using edge-computing architecture. The metric ingestion workers 3 receive information, including audio clips, Lidar, radar and ultrasonic data, which information and data may be encrypted locally prior to transmission to the database server. They perform the initial processing of statistical data before storing that data into the database server 4. The metric ingestion workers 3 also receive heartbeat signals from the base stations 8. Embodiments may make use of audio clips for calibration of the system.

The Web server and API 6 is preferably implemented using a REST (Representational State Transfer) software architecture. It is preferably run on the Lambda compute service of Amazon Web Services.

The Web API service functions to:
authenticate clients (preferably using OpenID or OAuth) for login of mobile client apps 11 and for machine-to-machine authentication and authorization between the base station 8 and smart tags 41 and the smart tags 42 (discussed below);
managing the presentation and updating of user information on the mobile device 11;
managing the pushes of alerts to the mobile device 11/mobile apps 12;
accept user feedback from the guest interface screen of the base station 8 and from the mobile apps 12; and
manage API documentation for integrations.

The watchman 7 runs partly on the base station 8 and largely on the back-end server 2. The watchman 7 is preferably implemented in the Python programming language, and preferably using the TensorFlow or PyTorch software libraries.

Each watchman 7 is individually calibrated for each installation to set appropriate levels based on inputs.

Input data to the watchman 7 preferably includes one or more of:
ambient temperature, ambient pressure and ambient humidity from the temperature/pressure/humidity monitor 29;
ambient noise level from the microphone 19;
audio clips;
carbon dioxide levels from the carbon dioxide sensor 27;
the beacon IDs of wireless sources withing range;
vibration from the accelerometer or accelerometers 32;
moisture;
the locations of any smart tags which are within range of the base station 8; and
location and/or movement of the base station 8.

Outputs and alerts from the watchman 7 include indicators of any one or more of:
excess noise detected;
excess people have been detected;
excess motion within the region that is monitored by the base station 8;
the breaking of glass;
air quality thresholds being exceeded;
items are missing within the region that is monitored by the base station 8;
the base station 8 is disconnected; and
the base station 8 has moved.

Models have been built using data models and are deployed to the watchman component 7 which runs on an EC2 instance.

The database server 4 is preferably implemented using a Postgres database with full schema (outside of authentication and alerts) for metrics, running a time-series table using TimescaleDB for analytics. The database server is hosted on the Amazon Elastic Compute Cloud (EC2) within Amazon Web Services (AWS).”

Although the above description of the software implementation of embodiments of the invention references specific languages and software packages, it will be readily apparent to skilled persons that alternative, suitable, languages and software packages are substitutable.

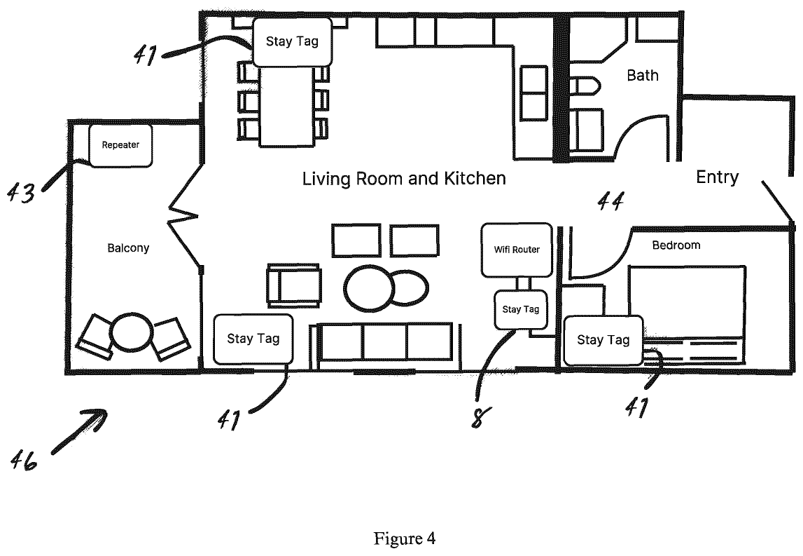

FIGS. 4 to 6 are plan views illustrating installations of apparatus according to exemplary embodiments of the present invention.

FIG. 4 is an illustration of such apparatus installed in a flat 46. Base station, in the form of base station 8 can intercommunicate with a WiFi router 44. The base station 8 and smart tags 41 can wirelessly intercommunicate, such as by Bluetooth or Zigbee protocols. The base station 8 and a repeater 43 can wirelessly intercommunicate, and the repeater 43 can wirelessly intercommunicate with other devices such as smart tags 41, smart tags 42, and mobile devices (which are not illustrated in the drawing). Preferred forms of the repeater 43 include: another base station 8, a compatible third-party device, and any other device that operates to enable the creation of a larger mesh network. The smart tags 41 are fixed to valuable devices, such as television receivers and artworks, which are intended to remain within the flat 46. The smart tags 42 are fixed to devices which move. Examples of such devices include bicycles for hire, and personalized medication packages such as a “Webster-pac”.

In this example, the base station 8 is placed adjacent the WiFi router 44 in the living room of the flat 46 to monitor this area. A repeater 43 is mounted on the balcony to monitor noise on the balcony. The three smart tags 41 are in various rooms and can wirelessly intercommunicate with either the base station 8 or the repeater 43.

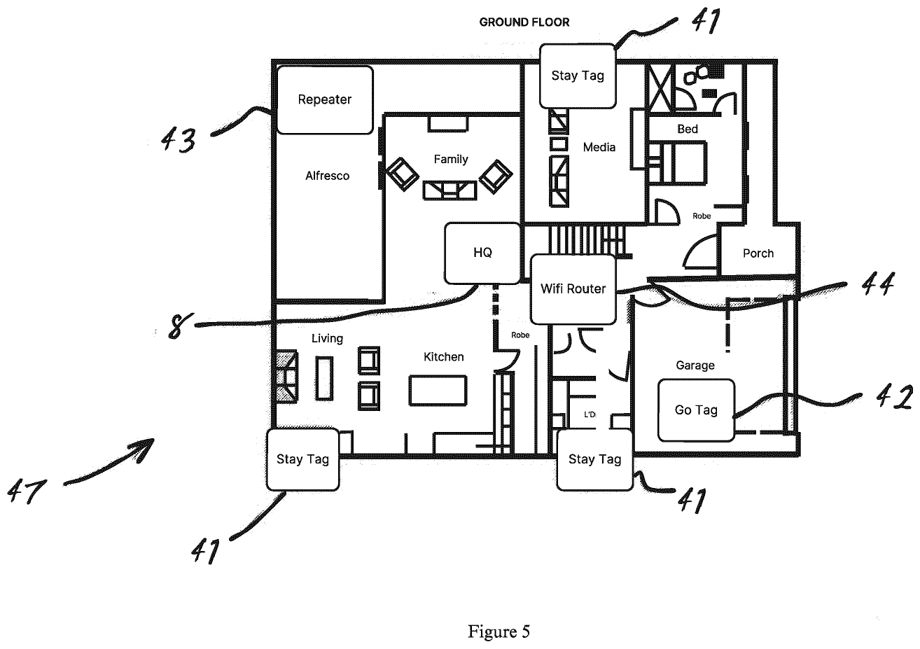

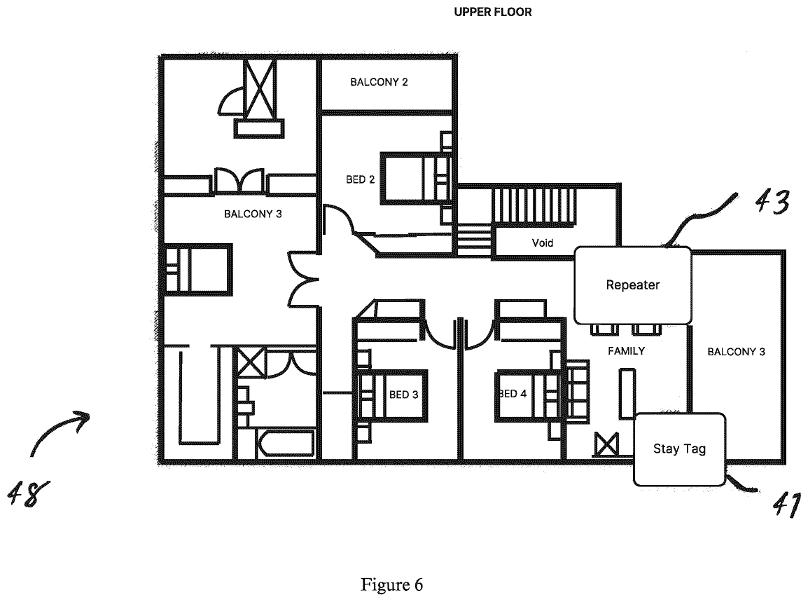

FIGS. 5 and 6 are, respectively, illustrations of apparatus according to an exemplary embodiment of the present invention in the ground floor 47 and upper floor 48 of a two-floor house. The base station 8, the WiFi router 44, the smart tags 41 and the repeater 43 operate in the same manner as do those components in the example of FIG. 4. The example of FIGS. 5 and 6 differ from the example of FIG. 4 in that it includes a go tag 42 which is attached to, for example, a bicycle which can be borrowed.

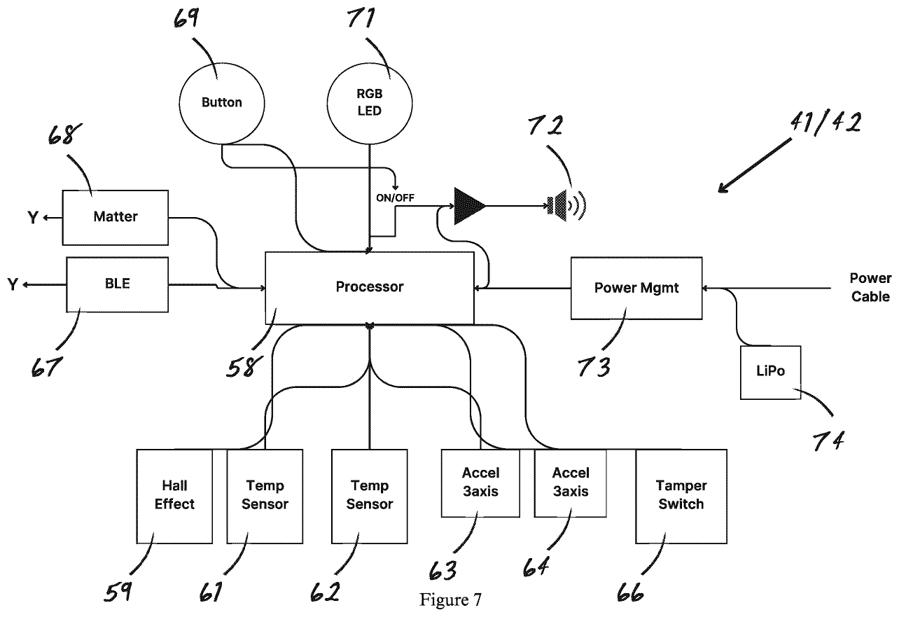

FIG. 7 is a high-level block diagram of a smart tag 41/42 according to embodiments of the present invention. As is illustrated in that drawing, the tag 41/42 operates under the control of the processor 58. The processor 58 receives input signals from a Hall effect detector 59, temperature sensors 61 and 62, three-axis accelerometers 63 and 64, and a tamper switch 66. The tag 41/42 communicates with the base station 8 via a Bluetooth Low Energy interface 67 and/or a “matter” interface 68. The human interface of tag 41/42 includes a control button 69, a LED 71 which is preferably an RGB led, and a speaker 72. The tag 41/42 is powered by a lithium-polymer battery 74 through a power management module 74.

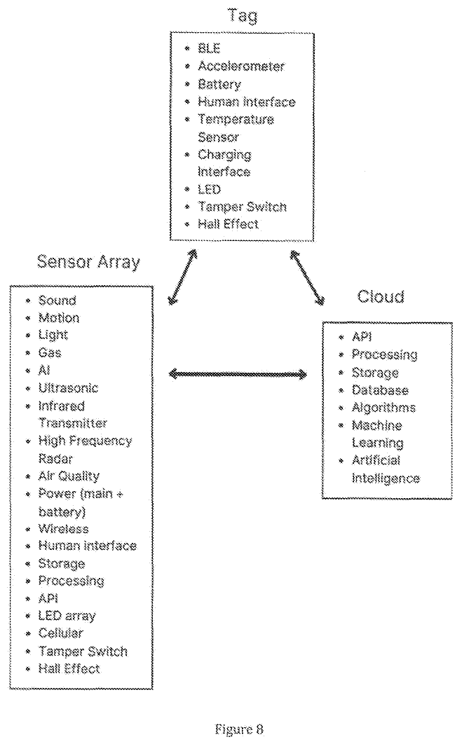

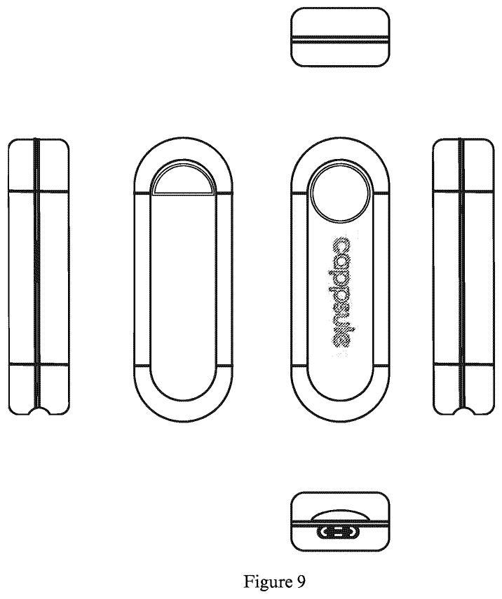

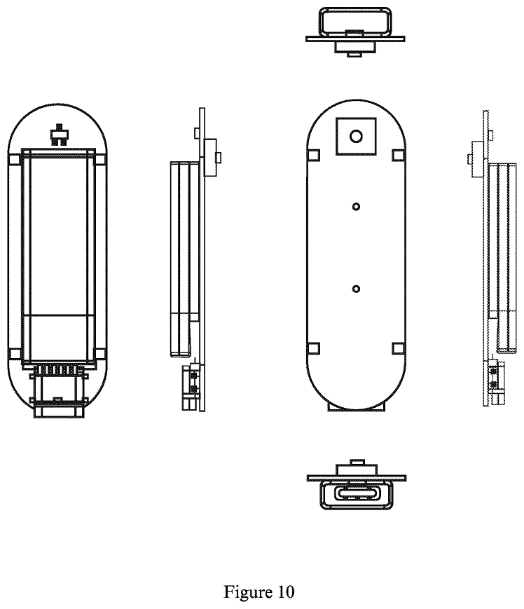

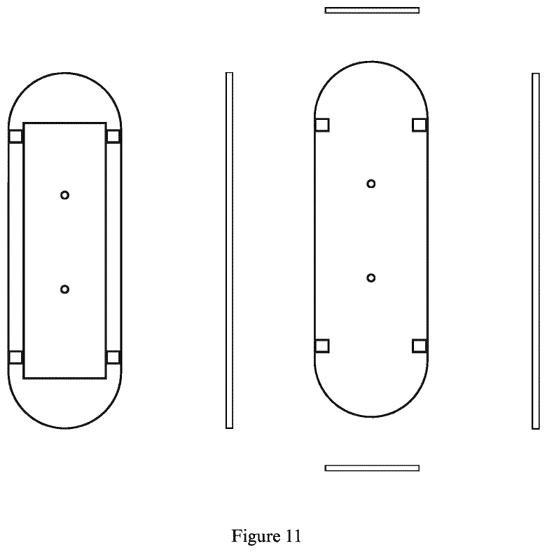

FIG. 8 is a set of charts which list the functionality, at a high-level, of resources which are used by the above-described the sensor array of the base station 8, the sensor array of the tags 41/42, and of the computing cloud of FIG. 3.

### Operation

In use, a PIR pyro-electric infra red (PIR) motion detector module 37 of the base station 8 detects motion within the range of that module and produces locational data in three dimensions. That locational data is segmented according to multiple horizontal and vertical segments. Classification of an object which has body heat into location by segment determines individual motion signatures of each object. That location of objects by segment contributes to allowing the determination of the number of persons, and/or pets, within the monitored volume of space.

A party detection algorithm uses data from a number of sources to infer whether or not a party is underway, where a party may be defined by determining a threshold number of persons and/or objects in the monitored volume of space is exceeded, and/or parameters such as, for example, noise levels or an air quality envelope of data are exceeding a threshold. Examples of data input to the party detection preferably include one or more of:
person count;
the increase in sound/noise volume above threshold;
the increase in carbon dioxide level; and
temperature increase.

The person count is determined by one or more of data from the PIR motion detector module 37, data from ultrasonic and/or radar modules (which are not illustrated in the figures), and the increase in a baseline number of wireless devices (Bluetooth and/or Wifi). Determining the increase in the baseline number of wireless devices uses data from:
the Bluetooth, Zigbee or other low power wireless interface 22 of the base station 8 (which listen for Bluetooth or other beacons); and/or;
the Wifi interfaces 23, 24 of the base station 8 (which listen for Bluetooth service set identifiers SSIDs).

Systems according to embodiments of the present invention create a baseline reading of the environment and uses machine learning to identify patterns and trends. For example:
how many wireless devices are normally nearby;
what is the normal ambient sound level;
is there something that changes these numbers routinely/periodically but which is normal (for example, a bus driving past could increase sound levels and the number of wireless devices detected).

According to some embodiments of the base station 8, input signals from the high frequency radar module 54 and the ultrasonic module 52 are processed to infer physiological information about persons. For example, information about a patient's heart rate and respiration rate.

The tags 41 and 42 both have inherent functionality and can interoperate with a base station. For example, a tag operating alone can determine whether a door has been opened. When that tag interoperates with a base station, using information from the base station, it becomes possible to make further inferences. For example, using shape detection it is possible to infer that the door has been opened by a person. It is also possible to infer whether that person is, for example, a patient rather than medical staff. By using machine learning/Al, it is possible to determine whether the patient's opening of the door goes against their regular behaviour patter.

The algorithmic processing is preferably split between the base station 8 and the server 2. For privacy reasons, some of the algorithms run locally on the base station 8 then stripped/encrypted and sent to server 2 for processing. Other non-sensitive data is processed on the server 2 alone.

Other non-sensitive data is processed on the server-side alone.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, any means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

The following sections I-VII provide a guide to interpreting the present specification.

### I. Terms

The term “base station” means one or more devices and/or components at one or more physical locations that functions in combination to provide processing, connection and communication of transceived (received or transmitted by the base station) data to a network.

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of’, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology Are Not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TOMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium II™, Xeon™, Celeron™, Pentium Pro™, Efficeon™, Athlon™, AMO™ and the like), programmable logic for use with a programmable logic device (e.g., a Field Programmable Gate Array (FPGA) or other PLO), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; Matlab; Miranda; Modula-2; Oberon; Pascal; Perl; PL/I; Prolog; Python; Rexx; SAS; Scheme; sed; Simula; Smalltalk; Snobol; SOL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e. g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLO programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

Changes and modifications in the specifically-described embodiments may be carried out without departing from the principles of the present invention, which is intended to be limited only by the scope of the appended claims as interpreted according to the principles of patent law including the doctrine of equivalents.

1. A system for monitoring activities within an enclosed environment, the system comprising:
at least a back-end server, a base station, a mobile device, or one or more sensors configured to detect an ambient temperature, an ambient pressure, an ambient sound or noise level, ambient carbon dioxide levels, beacon IDs of wireless sources, a vibration, a movement of objects, a movement of the base station, a location of smart tags, a location of animals, a movement of animals, or a physiological state of animals;
wherein the system is adapted to:
perform a processing comprising a preliminary analysis of data or an encryption of data;
send one or more measurements or data elsewhere for processing;
receive results of the local processing back at the base station; and
take action comprising one or a combination of: issuing an alert, a message, a prompt, a sound, a notification, and a display of measured levels.

2. The system as claimed in claim 1, wherein the one or more sensors are in communication and remotely located from the base station.

3. The system as claimed in claim 1, wherein at least one of the one or more sensors is integral with the base station.

4. The system as claimed in claim 1, wherein the sensor configured to detect the movement of objects comprises at least one pyro-electric infrared (PIR) motion detector.

5. The system as claimed in claim 1, wherein the smart tags comprise:
at least one RFID tag; and
at least one BLE tag.

6. The system as claimed in claim 1, wherein the processing identifies a spatial location of objects.

7. The system as claimed in claim 6, wherein the spatial location is in three dimensions.

8. The system as claimed in claim 6, wherein the objects comprise objects having body heat.

9. The system as claimed in claim 1, wherein the processing includes a local processing or a remote processing, and wherein the processing is configured to determine a number of persons or animals being within a sensing range of the one or more sensors.

10. The system as claimed in claim 1, wherein the processing is configured to detect if a party is underway.

11. The system as claimed in claim 1, wherein the processing is configured to determine:
a number of wireless devices that are within a range of the one or more sensors;
compare the number with a number of wireless devices that are historically within the range of the one or more sensors;
a number of persons that are within the range of the one or more sensors;
a level of carbon dioxide compared with a standard;
a temperature as compared with a normal temperature for a season and time of day; and
a random and predictable event.

12. The system as claimed in claim 11, wherein the random and predictable event is one or a combination of:
a bus driving past increasing sound levels; and
the number of wireless devices detected.

13. The system as claimed in claim 1, wherein the processing identifies a physiological state of a person or an animal.

14. The system as claimed in claim 13, wherein the physiological state includes a heart rate or a respiration rate.

15. A method of detecting activity that exceeds a predetermined threshold of activity in an enclosed environment, the method comprising the steps of:
detecting environmental or physical parameters of stationary and moving objects within the enclosed environment;
communicating the detected environmental or physical parameters to a base station for processing to determine which parameters exceed predefined parameter thresholds set respectively for each parameter;
signal any one or a combination of parameters that have been determined to exceed their predefined thresholds.

16. The method as claimed in claim 15, wherein the environmental or physical parameters are selected from one or a combination of:
air quality;
temperature,
pressure;
humidity;
noise levels;
carbon dioxide levels;
movement of objects;
breaking of glass;
absence of objects;
locations of smart tags;
the location of animals;
the movement of animals;
the physiological states of animals;
identification signals of wireless sources within communication range of the base station; and
location, movement or connection of a component of the base station.

17-33. (canceled)

34. A system for monitoring activities within an enclosed environment, the system comprising:
a back-end server, a base station, a mobile device, and one or more sensors configured to detect an ambient temperature, an ambient pressure, an ambient sound or noise level, ambient carbon dioxide levels, a vibration, a movement of objects, a movement of the base station, a location of smart tags, and a physiological state of humans or animals;
wherein the system is configured to:
perform a processing comprising a preliminary analysis of data or an encryption of data;
send one or more measurements or data elsewhere for processing;
receive results of the local processing at the base station; and
take action comprising one or a combination of: issuing an alert, a message, a prompt, a sound, a notification, and a display of measured levels.
